(19) United States
(12) Patent Application Publication
(10) Pub. No.: US 2015/0156830 A1
(43) Pub. Date: Jun. 4, 2015

(54) Power Supply Circuit for LED Lamp

(71) Applicant: Wanjiong Lin, Ningbo (CN)

(72) Inventors: Xuhong Ma, Ningbo (CN); Xiaoyong Zhou, Ningbo (CN); Huangfeng Pan, Ningbo (CN); Junjun Ying, Ningbo (CN); Wanjiong Lin, Ningbo (CN)

(73) Assignees: NINGBO SELF ELECTRONICS CO., LTD., Ningbo (CN); NINGBO HI-TECH PARK SELF ELECTRONICS CO., LTD., Ningbo (CN); SELF ELECTRONICS USA CORPORATION, Norcross, GA (US)

(21) Appl. No.: 14/550,608

(22) Filed: Nov. 21, 2014

(30) Foreign Application Priority Data
Dec. 4, 2013 (CN) 201310666731.5

(51) Int. Cl. H05B 33/08

(52) U.S. Cl. CPC H05B 33/0803

(57) ABSTRACT

A power supply circuit for LED lamp includes a portable power source, an inductance energy storage module, a current sensing module, an on/off controlling module, a switch configured for turning on or turning off the inductance energy storage module via the on/off controlling module according to the current value sensed by the current sensing module, and a timer configured for controlling the on/off controlling module to regulate time span of turn off the inductance energy storage module so that the peak current of the inductance energy storage module has same value in each charging-discharging period thereof. The power supply circuit has constant output power regardless of how long the portable power supply is used and how much electric energy it has. Constant current is realized when the power supply circuit has a constant load.

### RELATED APPLICATION

The present application claims the benefit of Chinese Application CN201310666731.5, filed on Dec. 4, 2013 with the State Intellectual Property Office of the People's Republic of China, the entire specification of which is incorporated by reference herein.

### BACKGROUND

1. Technical Field

The present application relates to lighting devices, and more particularly to a power supply circuit for LED lamp.

2. Description of the Related Art

For years, people have used traditional incandescent or fluorescence lighting apparatus in order to address their interior lighting concerns. However, such lighting apparatus presents a number of drawbacks. For example, the popular halogen apparatus presents the following drawbacks, such as relatively high power consumption, inefficiency of light dispersion due to the placement of its metal shield in the line of sight of the halogen bulb, and its limited effectiveness in preventing glare from the halogen bulb.

Recently, a number of LED lamps have been designed to replace the halogen apparatus, as well as other traditional incandescent or fluorescence lighting apparatuses, which are utilized in some commercial lighting, such as exhibition cabinet, horizontal freezer etc. However, some applications, such as drawer lights, flashlights, or decorative lighting, which are powered by batteries, are subject to certain limitations, such as battery capacity. Although these products are in sale in the market, performance thereof is not taken account of as same time as not to take account of cost, and vice versa. The LED lamp powered by battery has some features, such as large variation range of voltage, limited output current, limited storage capacity, and so on.

Two types of circuits are used in the products according to the feature of battery, which may be divided into high-end product and low-end product. The circuit of the low-end product is simple and current-limiting resistance is directly arranged into the circuit in series. The circuit has a low cost or no cost consumed in driving circuit. However, the simple circuit has some clear drawbacks, such as low circuit efficiency, low usage of power, large brightness variation following voltage change of battery, and so on. The high-end product has a complex circuit and has same design theory that output of battery flows into a DC/DC converter which output constant current into the LED lamp. Although this circuit adopts the DC/DC converter and has better performance than that of the low-end product, the circuit has drawbacks of high cost. Moreover, the circuit of the high-end product outputs constant current and constant power. Therefore, when voltage level of battery downs, the battery need to export larger current to maintain the constant power. As a result, actual working life of the battery may be reduced largely.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a circuit diagram of a power supply circuit for LED lamp in accordance with one embodiment of the disclosure.

FIG. 2 is a schematic view of the power supply circuit for LED lamp of FIG. 1.

### DETAILED DESCRIPTION

The present invention is illustrated by way of example and not by way of limitation in the figures of the accompanying drawings. It should be noted that references to “an” or “one” embodiment in this disclosure are not necessarily to the same embodiment, and such references mean at least one.

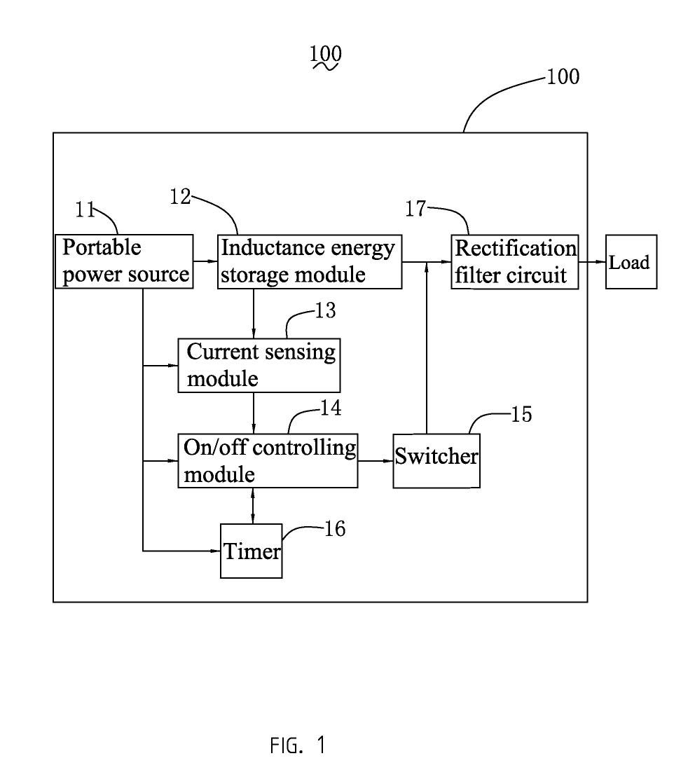

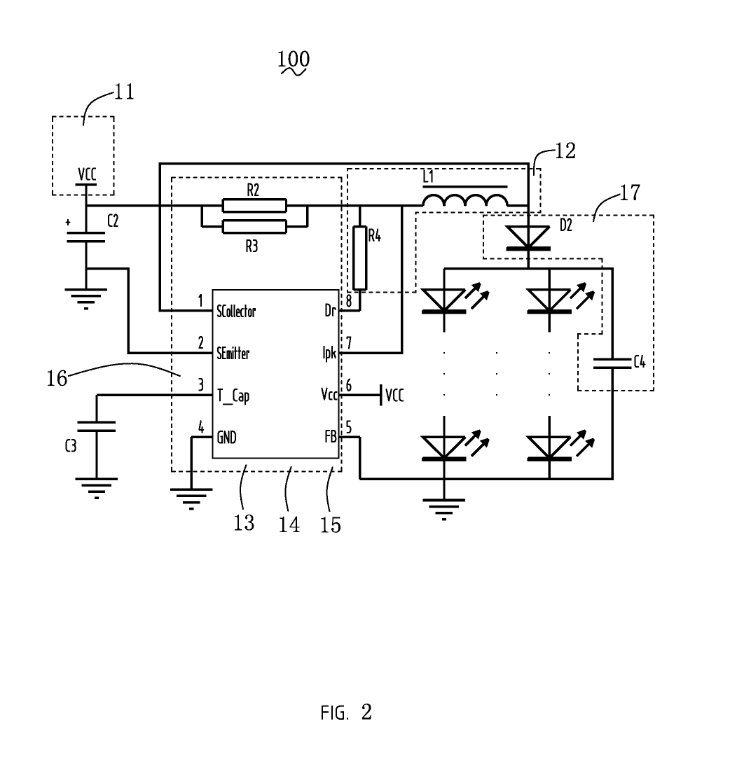

Referring to FIG. 1 to FIG. 2, a circuit diagram of a power supply circuit 100 for LED lamp according to the present invention is shown. The power supply circuit 100 for LED lamp includes a portable power source 11, an inductance energy storage module 12 electrically connected to the portable power source 11, a current sensing module 13 configured for sensing current value loaded on the inductance energy storage module 12, an on/off controlling module 14 electrically connected to the current sensing module 13, a switch 15 configured for turning on or turning off the inductance energy storage module 12 via the on/off controlling module 14 according to the current value sensed by the current sensing module 13, a timer 16 configured for controlling the on/off controlling module 14 to regulate time span of turning off the inductance energy storage module 12, and a rectification filter circuit 17 electrically connected to the output end of the inductance energy storage module 12.

The portable power source 11 may be served by a battery such as a dry battery, a storage battery, or a rechargeable battery, and so on, which can be ported with the LED lamp together. These batteries have the common feature that the output current and output voltage thereof vary with the change in electric quantity thereof. However, as is well known to a person skilled in the art, an LED chip is a constant current electron device. Therefore, it is necessary to transform the output current of the battery into a constant current.

The inductance energy storage module 12 includes an inductance L. The inductance L may be made of a magnetic core and a wire wound on the magnetic core. The magnetic core can be omitted or be replaced with a ferromagnetic material. The wire may be a copper wire. The inductance energy storage module 12 switches between charging and discharging according to the working principle of the inductance L that magnetic energy transforms into electrical energy and the electrical energy transforms into the magnetic energy. The time span of charging and discharging can be regulated on request, which is an emphasis in the present invention. The inductance L has a feature of volt-second balance, namely that the product of the voltage loaded on the inductance L and the charging time is equal to that of the voltage and the discharging time in a charging-discharging period. Moreover, the product is equal to that of the peak current value and the inductor unit. Therefore, when the peak current value and the inductance L are constant, the inductor unit also is a constant. However, with the reduction of electric quantity in the inductance energy storage module 12, the voltage value loaded on two end of the inductance L will decrease, and the charging time thereof will increase.

The current sensing module 13 functions to sense the current value loaded on the inductance L. In the present embodiment, the current sensing module 13 includes two sampling resistors R2, R3 connected in parallel. The two sampling resistors R2, R3 is configured for predetermining the peak current value of the current sensing module 13 and the trigger current value of the switch 15. The trigger current value functions to decide the switch 15 to turn on or turn off. Functions of the current sensing module 13, the on/off controlling module 14, the switch 15, and the timer 16 are carried out by a controller chip. The controller chip may be a central processing unit, a micro processor, or a microcontroller. In the present embodiment, the controller chip is the micro processor whose model is MC34063 which is well known for a person skilled in the art. The micro processor is an integrated chip so as to reduce cost. It is understood that the functions of the current sensing module 13, the on/off controlling module 14, the switch 15, and the timer 16 are carried out by a circuit designed of other electron components, such as triode, diode, CMOS, and so on.

The on/off controlling module 14 is configured for controlling the on or off of the switch 15 according to the current value sensed by the current sensing module 13 and loaded on the inductance energy storage module 12. When the current value sensed by the current sensing module 13 is larger than the trigger current value predetermined by the current sensing module 13, the on/off controlling module 14 can control the switch 15 to turn off the inductance energy storage module 12 which makes the inductance L stop to charge and begin to discharge. Therefore, in each charging-discharging period of the inductance L, the inductance L has a steady state peak current. Inversely, when the current value loaded on the inductance L is less than the trigger current value, and the on/off controlling module 14 is under the control of the timer 16, the on/off controlling module 14 controls the switch 15 to turn on the inductance energy storage module 12 which makes the inductance L stop to discharge and begin to charge.

The switch 15 is served by the above micro processor and is configured for turning on or turning off the inductance energy storage module 12 according to the instructions from the on/off controlling module 14 so as to control the inductance L to charge or discharge. The switch function of the micro processor is well known for a person skilled in the art and needs not to be described in detail.

The timer 16, as well as the on/off controlling module 14, the switch 15, is replaced by the above micro processor. Under the control of the timer 16, the time span of turning off the inductance L by the switch 15 via the on/off controlling module 14 has the same length. Since the output electric quantity per unit time reduces with the reduction of the battery's charger, it is necessary to increase the charging time of the inductance in order to make the power supply circuit 100 have constant power output and make the inductance energy storage module 12 have a constant peak current. As is well known for a person skilled in the art, because of the feature of volt-second balance of the inductance L, the charging time thereof must increase. Therefore, it is the important role of the timer 16 to regulate the time span of turning off the inductance L by the switch 15 via the on/off controlling module 14. That is to say, in each charging-discharging period, the peak current of the inductance energy storage module 12 has the same value and the inductance L has the same discharging time. Therefore, it can be understood that the charging-discharging period of the inductance energy storage module 12 may be longer when the battery's charger reduces as the charging time may be increased. In order to be sure that the inductance L can discharge fully, the time span of turning off the inductance L may be longer than that of discharging thereof. As a result, the inductance energy storage module 12 can discharge fully in each of the charging-discharging periods so as to prevent next charge level thereof reducing because of non-fully discharging.

The rectification filter circuit 17 includes a diode D2 and a capacity C4 electrically connected to the diode D2 in series. As well known, the power supply circuit 100 for LED lamp includes at least a load of an LED chip. The LED chip should be electrically connected with two ends of the capacity C4 and the LED lamp has a cathode electrically connected to ground. The rectification filter circuit 17 is connected to the output end of the inductance energy storage module 12 and is configured for converting the output current of the inductance energy storage module 12 into a constant current for the LED chip.

In use, under the cooperated control of the current sensing module 13, the on/off controlling module 14, the switch 15, and the timer 16, the inductance energy storage module 12 has the same peak current which is equal to the trigger current value predetermined by the current sensing module 13 in each of charging-discharging periods. That is to say, only when the peak current of the inductance energy storage module 12 is equal to or larger than the trigger current value, the switch 15 may turn off the inductance energy storage module 12 so as to stop the inductance L to charge. If not, the inductance energy storage module 12 will be charged until the current loaded thereon comes to the peak current thereof. As a result, it can be ensured that the current loaded on the inductance energy storage module 12 can rise into the peak current thereof in each of charging-discharging periods. When the portable power source 11 has abundant power in the beginning of use and has a large output, under the control of the timer 16, the time in which the current loaded on the inductance energy storage module 12 rises to the trigger current value is short. When the portable power source 11 has no abundant power after a while of use and has a lower output, the time in which the current rises to the trigger current value is longer. Therefore, the power supply circuit 100 has a constant output power regardless of how long the portable power supply 11 is used and how much electric energy it has. As a result, a constant current is realized when the power supply circuit 100 has a constant load. When the battery has no abundant power and a lower voltage output, it has longer time in which the switch 15 turns on the inductance energy storage module 12. In result, the current loaded on the inductance L will reduce automatically, which will increase the service life of the battery since the lifetime thereof can be drastically reduce when the battery discharges in a non-normal current as well known.

While the present invention has been described by way of example and in terms of exemplary embodiment, it is to be understood that the disclosure is not limited thereto. To the contrary, it is intended to cover various modifications and similar arrangements (as would be apparent to those skilled in the art. Therefore, the scope of the appended claims should be accorded the broadest interpretation so as to encompass all such modifications and similar arrangements.

What is claimed is:

1. A power supply circuit for LED lamps comprising:
a portable power source;
an inductance energy storage module electrically connected to the portable power source;
a current sensing module configured for sensing a current value loaded on the inductance energy storage module;
an on/off controlling module (14) electrically connected to the current sensing module;
a switch configured for turning on or turning off the inductance energy storage module via the on/off controlling module according to the current value sensed by the current sensing module; and
a timer configured for controlling the on/off controlling module to regulate a time span of turning off the inductance energy storage module so that the peak current of the inductance energy storage module has the same value in each of charging-discharging periods thereof.

2. The power supply circuit for LED lamp of claim 1, wherein the portable power source is a battery.

3. The power supply circuit for LED lamp of claim 1, wherein the current sensing module predetermines a trigger current value, when the current value loaded on the inductance energy storage module is equal to or larger than the trigger current value, and the on/off controlling module controls the switch to turn off the inductance energy storage module.

4. The power supply circuit for LED lamp of claim 1, wherein the time span of turning off implemented by the switch has the same length in each of the charging-discharging periods of the inductance energy storage module.

5. The power supply circuit for LED lamp of claim 1, wherein the time span of turning off the inductance energy storage module is longer than that of discharging of the inductance energy storage module.

6. The power supply circuit for LED lamp of claim 1, wherein functions of the current sensing module, the on/off controlling module, and the switch are carried out by a controller chip.

7. The power supply circuit for LED lamp of claim 6, wherein the controller chip is a central processing unit, microprocessor, or a micro chip microcomputer.

8. The power supply circuit for LED lamp of claim 1, wherein the power supply circuit for LED lamp further comprises a rectification filter circuit, the rectification filter circuit is connected to the output end of the inductance energy storage module and is configured for converting the output current of the inductance energy storage module into a constant current.

9. The power supply circuit for LED lamp of claim 1, wherein the current sensing module comprises tow sampling resistances R1, R2 arranged in parallel, the two sampling resistances R1, R2 are used for setting the trigger current value of the current sensing module, and the trigger current value decides the time to turn on or turn off via the switch.

10. The power supply circuit for LED lamp of claim 1, wherein the power supply circuit for LED lamp is used for supplying power for at least one LED lamp, wherein the LED lamp has a cathode electrically connected to ground.
